(19) United States
(12) Patent Application Publication
(10) Pub. No.: US 2023/0400235 A1
(43) Pub. Date: Dec. 14, 2023

(54) GAS ENGINE AIR-CONDITIONING DEVICE

(71) Applicant: Rise Pit Company Co., Ltd., Tokyo (JP)

(72) Inventor: Masahiro YAMAZAKI, Tokyo (JP)

(21) Appl. No.: 18/202,031

(22) Filed: May 25, 2023

(30) Foreign Application Priority Data
Jun. 14, 2022 (JP) 2022-096001
Feb. 10, 2023 (JP) 2023-018904

(51) Int. Cl. F25B 27/00; F25B 13/00; F01P 7/14; F02B 63/06; F02B 63/04; F01P 3/18; F01P 5/02

(52) U.S. Cl. CPC F25B 27/00; F25B 13/00; F01P 7/14; F02B 63/06; F02B 63/042; F01P 3/18; F01P 5/02; F01P 2007/146; F01P 5/10

(57) ABSTRACT

A gas engine air-conditioning device includes an outdoor unit having a gas engine, a first cooling water circulation flow passage and a second cooling water circulation flow passage, a first radiator, a second radiator, a water passage switch valve, a gas engine direct current power generator, a motor, a compressor, a condenser, and first fan, and a second fan, and is configured such that during heating, cooling water is circulated through the first cooling water circulation flow passage by a water passage switch valve, high-temperature passing air is sent from the first radiator, which reaches a high temperature, to the condenser by the first fan, and a refrigerant compressed by the compressor is circulated to an indoor unit, and during cooling, the cooling water is caused to flow through the second cooling water circulation flow passage by the water passage switch valve.

### BACKGROUND OF THE INVENTION

### 1. Field of the Invention

The present invention relates to a gas engine air-conditioning device with which an air-conditioning device is operated efficiently using a small gas engine and a direct current power generator.

### 2. Description of the Related Art

In recent years, a large number of systems that operate air-conditioning devices using a gas engine have come into use. Moreover, air-conditioning devices that use heat pumps are also increasing. In an air-conditioning device, a compressor is provided in a refrigerant circuit. The gas engine drives the compressor. This type of system is known as a gas engine heat pump. An advantage of this type of air-conditioning device is that it can be operated at low cost.
Patent Literature 1: Japanese Patent Application Publication No. 2005-257102
Patent Literature 2: Japanese Patent Application Publication No. 2003-4332

### SUMMARY OF THE INVENTION

As regards the configuration for driving the compressor in an air-conditioning device operated by a gas heat pump that uses a gas engine, in many cases a structure for driving the compressor is realized by directly connecting the gas engine to the compressor. Moreover, this structure includes the following configurations. In a first structure, a drive shaft of the gas engine is directly connected to a rotary shaft of the compressor. In a second structure, rotation is transmitted by connecting the gas engine and the compressor via a belt. In a third structure, rotation is transmitted by connecting the gas engine and the compressor via a chain.

In these cases, the gas engine and the compressor are either directly connected or connected via a belt, a chain, or the like, and in all of these cases, the rotation of the gas engine is directly transmitted to the compressor such that excessive power is applied to the compressor. Almost all of the power applied to the compressor is excessive power not required to operate the air-conditioning system, and therefore the power is wasted. Furthermore, vibration generated during an operation of the gas engine may be transmitted to the compressor such that an excessive load is exerted on the compressor. Moreover, due to torque variation occurring during the operation of the gas engine, the operation of the compressor may become unstable.

In addition, when rotation is transmitted by providing a belt or a chain between the gas engine and the compressor, the tension of the belt or chain must be adjusted to an appropriate tension, and a space for the belt or the chain must be provided in the gas engine, and these factors greatly affect management costs.

Furthermore, in an air-conditioning device operated by a gas heat pump that uses a gas engine, a central portion of a housing in which instruments such as the gas engine and a power generator are housed is likely to be heated to an extremely high temperature by the heat of the instruments, and moreover, during cooling, the refrigerant temperature at the inlet of a condenser (heat exchanger) may become too low. Hence, it may be extremely difficult to manage the temperature of the refrigerant used for air-conditioning.

A problem (technical problem, object, or the like) to be solved by the present invention is to eliminate the inconveniences described above, which are caused by employing direct connection as a mechanism for transmitting rotation between the gas engine and the compressor, thereby achieving a further improvement in the efficiency of an air-conditioning operation performed by a gas heat pump that uses a gas engine.

As a result of committed and repeated research carried out with the aim of solving the problem described above, the inventor solved the problem described above by employing, as a first aspect of the present invention, a gas engine air-conditioning device having an outdoor unit that includes: a gas engine; a first cooling water circulation flow passage and a second cooling water circulation flow passage through which cooling water of the gas engine circulates; a first radiator provided in the first cooling water circulation flow passage; a second radiator provided in the second cooling water circulation flow passage; a water passage switch valve for circulating the cooling water through either the first cooling water circulation flow passage or the second cooling water circulation flow passage; a direct current power generator driven by the gas engine; a motor operated by the direct current power generator; a compressor driven by the motor to compress a refrigerant; a condenser for performing heat exchange on the refrigerant; a first fan provided on the first radiator side; and a second fan provided on the second radiator side, the gas engine air-conditioning device configured such that during heating, the cooling water is circulated through the first cooling water circulation flow passage by the water passage switch valve, high-temperature passing air is sent from the first radiator, which reaches a high temperature, to the condenser by the first fan, and the refrigerant compressed by the compressor is circulated to an indoor unit, and during cooling, the cooling water is caused to flow through the second cooling water circulation flow passage by the water passage switch valve, and surplus power generated by the direct current power generator in accordance with the output of the gas engine is supplied to the outside as an alternating current power supply.

The problem described above was solved by making a second aspect of the present invention the gas engine air-conditioning device according to the first aspect, wherein the second fan is capable of changing a direction of passing air sent to the second radiator. The problem described above was solved by making a third aspect of the present invention the gas engine air-conditioning device according to the second aspect, wherein the second fan includes a plurality of blades, each blade has a blade central portion formed in an intermediate location along a rotation direction, the blade central portion having a flat plate shape and inclining along the rotation direction, and blade end portions formed on the two rotation direction ends of the blade central portion so as to incline along the rotation direction, and attack angles of the two blade end portions are set to be identical and smaller than an attack angle of the blade central portion.

The problem described above was solved by making a fourth aspect of the present invention the gas engine air-conditioning device according to the first or second aspect, the gas engine air-conditioning device further including an ECU and a TCU, wherein an assembly of the gas engine, the ECU, and the direct current power generator is housed in a first housing as a power unit, an assembly of the motor, the compressor, the condenser, the first radiator, and the first fan is housed in a second housing as a compressor unit, and the first cooling water circulation flow passage is provided between the first housing and the second housing so as to connect the first housing and the second housing.

The problem described above was solved by making a fifth aspect of the present invention the gas engine air-conditioning device according to the fourth aspect, wherein the first housing is provided singly, and second housings are arranged in parallel via the first cooling water circulation flow passage. The problem described above was solved by making a sixth aspect of the present invention the gas engine air-conditioning device according to the fourth aspect, wherein the first housing is provided singly, second housings are arranged in parallel via the first cooling water circulation flow passage, and each of the second housings is provided with a plurality of indoor units arranged in parallel via a refrigerant circulation passage.

The problem described above was solved by making a seventh aspect of the present invention the gas engine air-conditioning device according to the first or second aspect, wherein a direct current motor is used as the motor, and a motor output control device is provided to supply appropriate power between the direct current power generator and the motor. The problem described above was solved by making an eighth aspect of the present invention the gas engine air-conditioning device according to the first or second aspect, wherein an alternating current motor is used as the motor.

In the present invention, the compressor is not driven directly by the gas engine, and instead, power from the direct current power generator is increased or reduced by adjusting excitation electricity using the TCU (general controller), whereupon this power is supplied to the direct current motor for driving the compressor so that during heating, a heat exchanger part of the indoor unit is warmed by heated air. In a system where the compressor is driven directly by the gas engine, the compressor receives surplus power exceeding the heat exchange amount (kw) of the indoor unit, and this power may be wasted. According to the present invention, this waste can be avoided.

Further, when a large number of compressors are driven by a gas engine via a belt, a chain, or the like, a large amount of waste occurs in terms of power transmission and space, and adverse effects such as vibration are transmitted, but according to the present invention, this problem can be eliminated. Moreover, since the compressor is not driven directly by the gas engine, the risk of vibration occurring due to mutual interference between torque variation in the gas engine and cogging (an awkward jerking motion accompanying compression) in the compressor is completely eliminated.

Furthermore, by supplying the surplus power generated by the direct current power generator in accordance with the output of the gas engine to the outside as an alternating current power supply, the surplus power generated by the gas engine and the direct current power generator can be used as an alternating current power supply and can therefore be used effectively.

### BRIEF DESCRIPTION OF THE DRAWINGS

FIG. 1A is a system diagram of a gas engine air-conditioning device according to the present invention, and

FIG. 1B is a schematic view showing a configuration of output control from a direct current power generator to a direct current motor, performed by a controller shown in FIG. 1A;

FIG. 2 is an overall system diagram showing an operation state during heating by the gas engine air-conditioning device according to the present invention;

FIG. 3 is an operation diagram showing a flow of refrigerant during heating by the gas engine air-conditioning device according to the present invention;

FIG. 4 is an operation diagram showing directions of passing air from a first fan on a compressor unit side to a first radiator and a condenser during heating by the gas engine air-conditioning device according to the present invention;

FIG. 5 is an overall system diagram showing an operation state during cooling by the gas engine air-conditioning device according to the present invention;

FIG. 6 is an operation diagram showing the flow of the refrigerant during cooling by the gas engine air-conditioning device according to the present invention;

FIG. 7 is an operation diagram showing the directions of the passing air from the first fan on the compressor unit side to the first radiator and the condenser during cooling by the gas engine air-conditioning device according to the present invention;

FIG. 8 is a system diagram showing a configuration in which a power unit and the compressor unit of the gas engine air-conditioning device according to the present invention are respectively housed in separate housings;

FIG. 9 is a system diagram showing a configuration of the gas engine air-conditioning device according to the present invention in which a plurality of compressor units is arranged in parallel in relation to a single power unit;

FIGS. 10A, 10B, and 10C are views showing a configuration in which a general housing in which the power unit and the compressor unit are housed is cooled by the first fan and a second fan;

FIG. 11A is a front view of the second fan, which rotates forward and in reverse, FIG. 11B is a side view of the second fan, FIG. 11C is a sectional view seen along an arrow Xl-Xl in FIG. 11A, FIG. 11D is an enlarged view of a blade part of FIG. 11C, and FIG. 11E is a perspective view showing a partial cross-section of the blade part of the fan;

FIG. 12A is a side view showing a partial cross-section of a state in which a coupling, a flywheel, and the direct current power generator are separated, FIG. 12B is a longitudinal sectional side view of the coupling, FIG. 12C is a front view of the coupling, and FIG. 12D is a sectional view seen along an arrow Y1-Y1 in FIG. 12B;

FIG. 13 is a schematic view showing a configuration of a gas engine;

FIG. 14A is a partially cut-away side view of a main refrigerant passage switch valve and a secondary refrigerant passage switch valve, and FIG. 14B is a cross-sectional plan view of FIG. 14A;

FIGS. 15A to 15C are views showing configurations of the direct current motor and the controller;

FIG. 16A is a system diagram of an embodiment of the gas engine air-conditioning device according to the present invention in which an alternating current power generator and an alternating current motor are used, and FIG. 16B is a schematic view showing a configuration of output control from the alternating current power generator to the alternating current motor, performed by a controller of FIG. 16A;

FIG. 17 is an overall system diagram showing an operation state during heating by the embodiment of the present invention that uses an alternating current power generator and an alternating current motor;

FIG. 18A is a view showing a configuration for controlling the alternating current power generator and the alternating current motor, and FIG. 18B is a detailed view of section (a) of FIG. 18A; and

FIG. 19A is a system diagram of an embodiment of the gas engine air-conditioning device according to the present invention in which an alternating current power generator and a direct current motor are used, and FIG. 19B is a schematic view showing a configuration of output control from the alternating current power generator to the direct current motor, performed by a controller of FIG. 19A.

### DESCRIPTION OF THE PREFERRED EMBODIMENTS

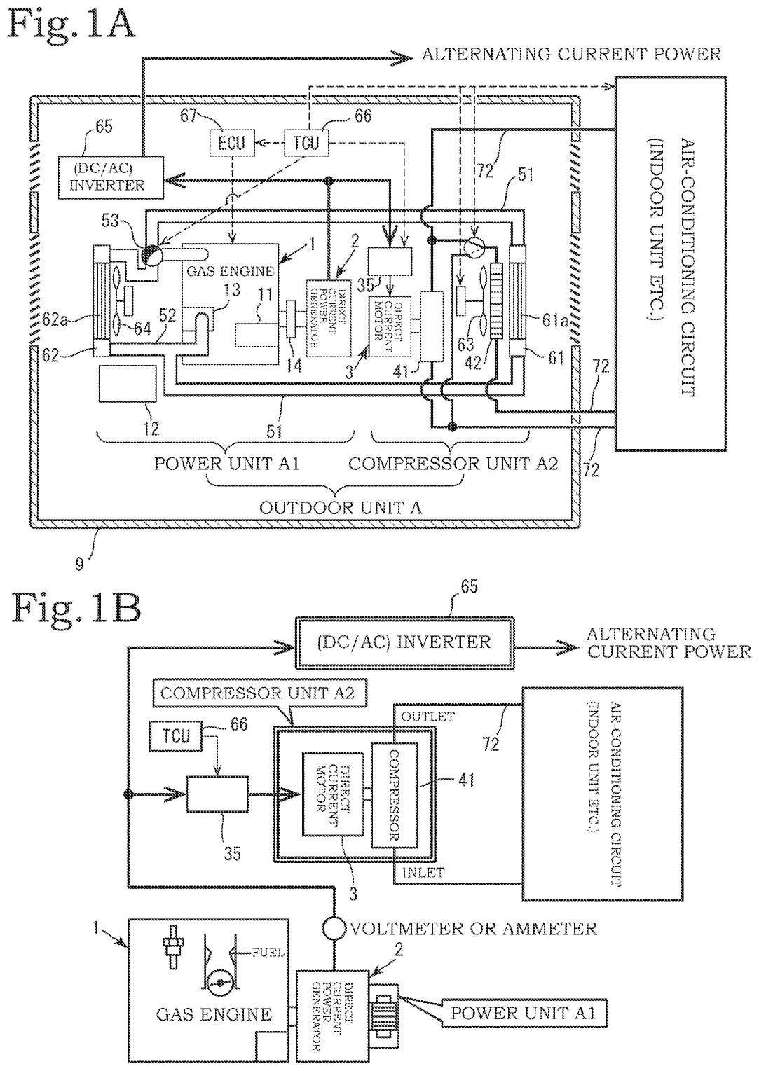

Embodiments of the present invention will be described below on the basis of the figures. The present invention is mainly constituted by a power unit A1 and a compressor unit A2, to which an indoor unit assembly is added (see FIGS. 1A, 1B, 2, 5, and so on). An outdoor unit A is constituted by the power unit A1, the compressor unit A2, and a housing (a general housing 9 or a first housing 91), to be described below. The power unit A1 is formed by assembling a gas engine 1, a direct current power generator 2, a first cooling water circulation flow passage 51, a second cooling water circulation flow passage 52, a second radiator 62, and a second fan 64 (see FIGS. 1A, 1B, 2, 5, and so on). In many cases, the outdoor unit A is installed indoors in a building or a housing complex such as a condominium or apartment building, and is often installed in a basement, a machine room, or the like of the building, for example. The outdoor unit A may also be installed on the outside of the building, similarly to a normal air-conditioning device.

The compressor unit A2 is formed by assembling a motor 3, a compressor 41, a first radiator 61, a condenser 42, and a first fan 63. The indoor unit assembly is constituted by a refrigerant flow passage 72, an indoor unit 71, and so on. Here, the motor 3 will be described below as a direct current motor, but the present invention also includes a case in which an alternating current motor 3A is used as an embodiment of the motor 3, and the alternating current motor 3A will be described at the end of the description.

In the following description, the motor 3 is a direct current motor, but when the motor 3 is an alternating current motor, a reference symbol 3A will be attached and the motor 3 will be described as an alternating current motor 3A. Note that in the following description, in locations where it is to be emphasized that the motor 3 is a direct current motor, the motor 3 will be described as a direct current motor 3. Furthermore, in the figures, in embodiments where a direct current motor is used, the motor 3 is described as a direct current motor, and in embodiments where an alternating current motor is used, the motor 3 is described as an alternating current motor.

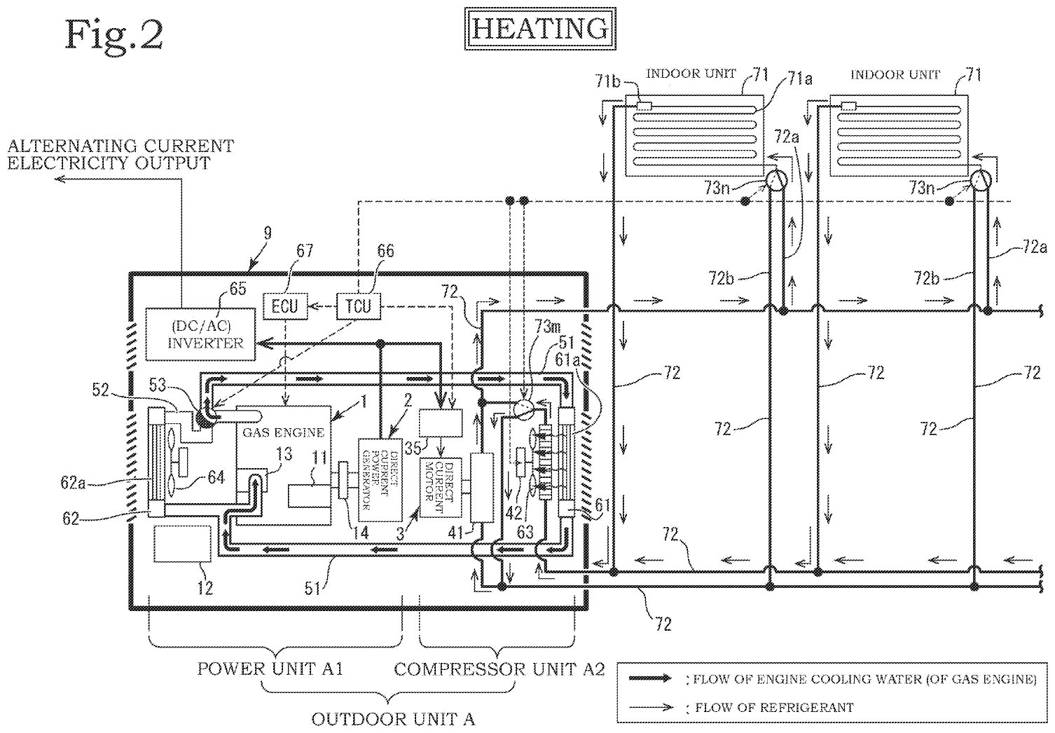

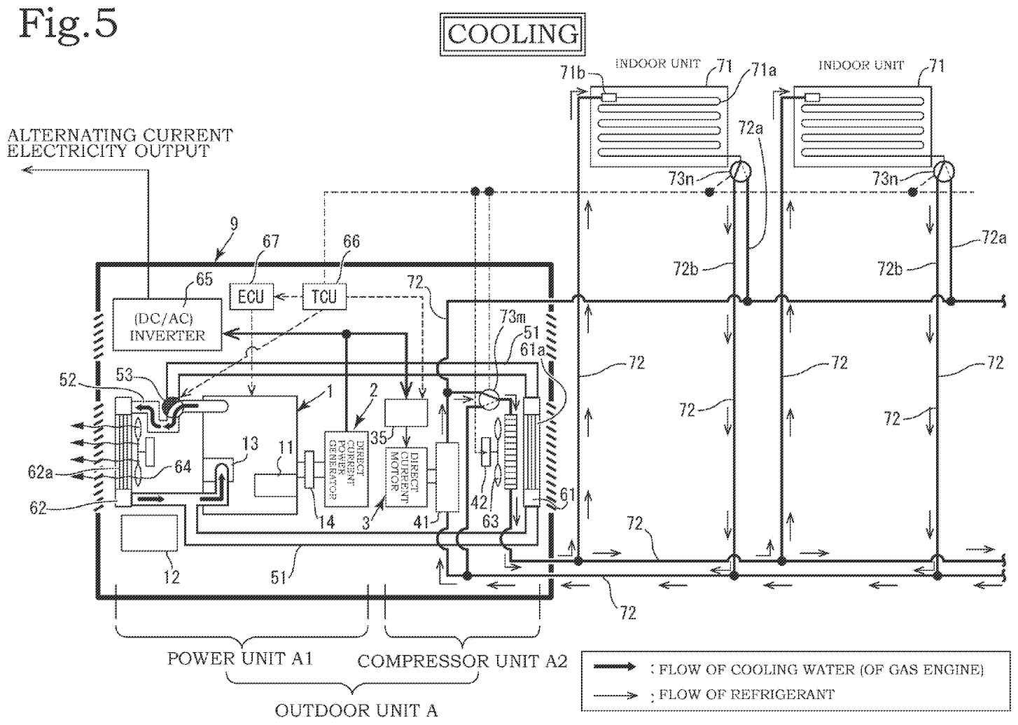

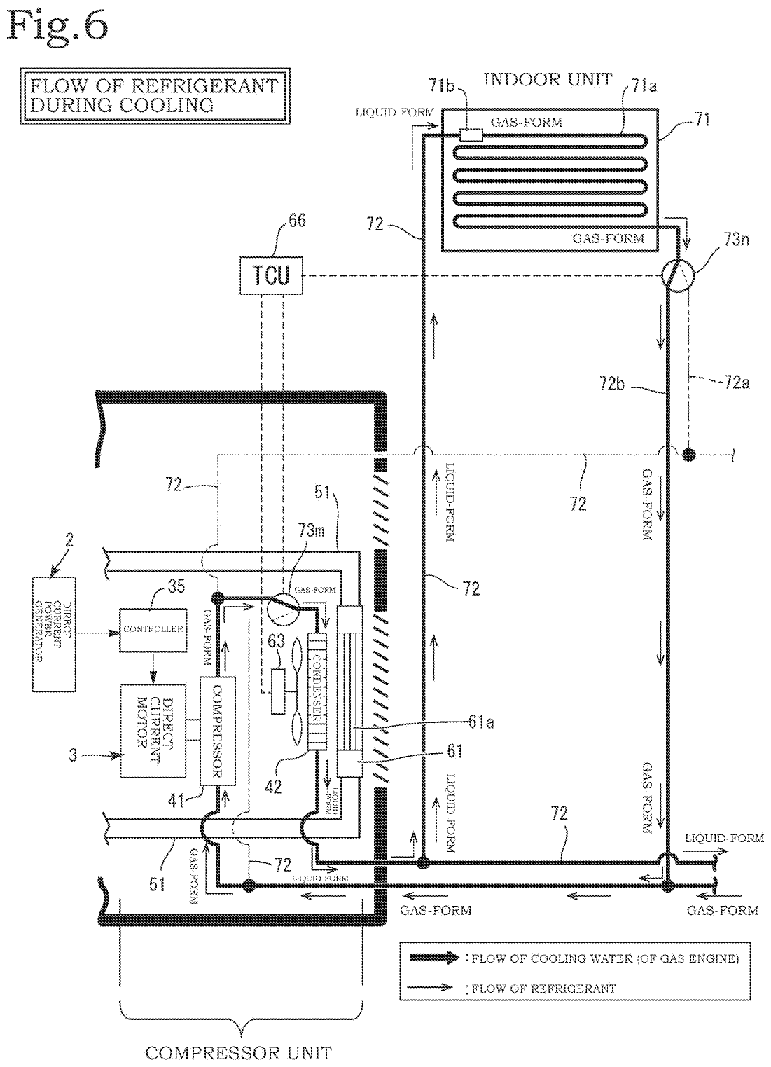

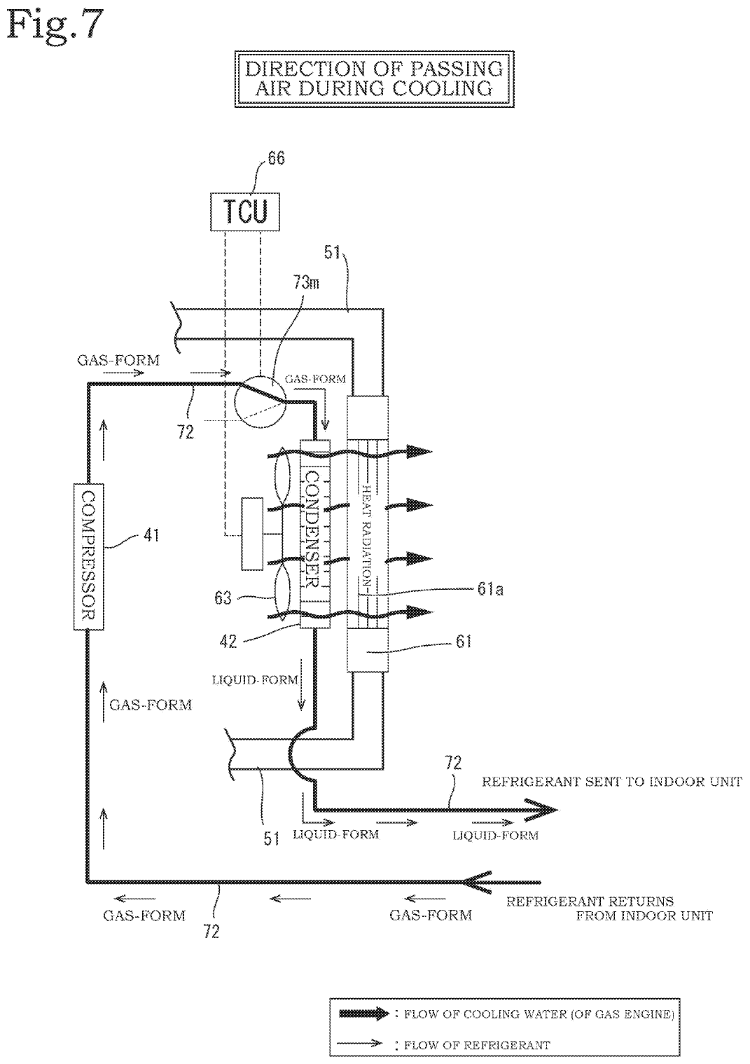

The power unit A1 and the compressor unit A2 are connected such that cooling water of the gas engine 1 can be circulated by the first cooling water circulation flow passage 51 (see FIGS. 1A, 1B, 2, 5, and so on). Further, the compressor unit A2 is connected to the indoor unit 71 by the refrigerant flow passage 72. The refrigerant flow passage 72 includes a heating refrigerant flow passage 72a and a cooling refrigerant flow passage 72b. The heating refrigerant flow passage 72a is a flow passage (piping) through which refrigerant flows during heating (see FIGS. 2 to 4), and the cooling refrigerant flow passage 72b is a flow passage (piping) through which refrigerant flows during cooling (see FIGS. 5 to 7).

The compressor unit A2 and the heating refrigerant flow passage 72a or the cooling refrigerant flow passage 72b function to supply refrigerant in a suitable state for heating or cooling to the indoor unit 71. The power unit A1 and the compressor unit A2 are incorporated together into the single general housing 9. The outdoor unit A is constituted by the power unit A1, the compressor unit A2, and the general housing 9.

The condenser 42 may also be referred to as a heat exchanger. More specifically, during heating, the condenser 42 acts as a heat exchanger that increases the temperature of refrigerant gas at the inlet of the compressor 41 by acquiring heat from the air. Further, during cooling, the condenser 42 functions to expose the heat of the refrigerant gas, which has reached a high temperature by being compressed by the compressor 41, to passing air so that the refrigerant gas is condensed into liquid form.

In the power unit A1, the gas engine 1 and the direct current power generator 2 are connected by a coupling 14, and by driving the gas engine 1, the direct current power generator 2 generates power (see FIGS. 1A and 1B). The power generated by the direct current power generator 2 is transmitted to the compressor unit A2 side and supplied to the motor 3 via a controller 35. On the compressor unit A2 side, the motor 3 drives the compressor 41.

The first cooling water circulation flow passage 51 and the second cooling water circulation flow passage 52 are provided in the gas engine 1 of the power unit A1 (see FIGS. 1A and 1B to 7 and so on). The first cooling water circulation flow passage 51 and the second cooling water circulation flow passage 52 both circulate cooling water, and the first cooling water circulation flow passage 51 and the second cooling water circulation flow passage 52 are configured such that the cooling water is caused to flow through only one circulation flow passage by a water passage switch valve 53 (see FIGS. 1A and 1B to 7 and so on).

The first cooling water circulation flow passage 51 is arranged to extend between the power unit A1 and the compressor unit A2 through the gas engine 1. The second cooling water circulation flow passage 52 is disposed only in the gas engine 1 of the power unit A1. In the outdoor unit A, the cooling water circulates through the first cooling water circulation flow passage 51 during heating and circulates through the second cooling water circulation flow passage 52 during cooling.

The first cooling water circulation flow passage 51 is provided between the power unit A1 and the compressor unit A2 and is used to cool the gas engine 1 and also to manage the temperature of the condenser 42. The second cooling water circulation flow passage 52 is used to perform cooling in the power unit A1 while the gas engine 1 is driven. The cooling water is caused to flow through either the first cooling water circulation flow passage 51 or the second cooling water circulation flow passage 52 by the water passage switch valve 53, and does not flow through both circulation flow passages simultaneously.

The first cooling water circulation flow passage 51 and the second cooling water circulation flow passage 52 partly share the same flow passage on an inlet side and an outlet side of the gas engine 1 (see FIGS. 1A, 2, 3, and so on). The water passage switch valve 53 is provided in the outlet-side flow passage. The water passage switch valve 53 is operated by a TCU (general controller) 66 to switch to either the first cooling water circulation flow passage 51 or the second cooling water circulation flow passage 52 depending on whether heating or cooling is underway.

The second cooling water circulation flow passage 52 is provided in the gas engine 1 of the power unit A1, and the second radiator 62 is provided in the second cooling water circulation flow passage 52. The second fan 64 is provided for the second radiator 62, and the second fan 64 is used to apply passing air to the second radiator 62. The second cooling water circulation flow passage 52 only cools the gas engine 1.

The first cooling water circulation flow passage 51 is arranged to extend between the power unit A1 side and the compressor unit A2 side, the first radiator 61 is provided in the first cooling water circulation flow passage 51, and the first fan 63 is provided close to the first radiator 61. Further, the condenser 42 is disposed between the first radiator 61 and the first fan 63. Passing air is applied to the first radiator 61 by the first fan 63, and this passing air affects the temperature of the condenser 42. In other words, the temperature of the condenser 42 is adjusted by the first cooling water circulation flow passage 51, the first radiator 61, and the first fan 63.

On the compressor unit A2 side, the compressor 41 and the condenser 42 are incorporated into the refrigerant flow passage 72 such that refrigerant flows into the compressor 41 and the condenser 42. The indoor unit 71 is attached to the refrigerant flow passage 72. Thus, an air-conditioning system is constituted by the compressor unit A2 serving as the outdoor unit A and the indoor unit 71 (see FIGS. 1A and 1B to 7).

Next, a cooling operation and a heating operation will be described on the basis of FIGS. 2 to 7. First, the configuration of the air-conditioning system, the flows of the refrigerant and the engine cooling water, and the operations of the air-conditioning system will be described. Thick, solid lines in FIGS. 1A and 1B to 7 denote the refrigerant flow passage (refrigerant piping) 72. Further, arrows printed on the refrigerant flow passage 72 indicate the flow direction of the refrigerant during cooling and heating. Furthermore, dotted lines (chain lines) illustrated between the refrigerant flow passage 72 and the TCU (general controller) 66 denote signal lines of the TCU (general controller) 66.

In the present invention, either heating or cooling is selected directly in accordance with a command from the TCU (general controller) 66, and in response to this command, the water passage switch valve 53 on the power unit A1 side is operated so as to switch between the first cooling water circulation flow passage 51 and the second cooling water circulation flow passage 52, and the refrigerant flow passage 72 on the compressor unit A2 side is switched between the heating refrigerant flow passage 72a and the cooling refrigerant flow passage 72b by switching operations performed by a main refrigerant passage switch valve 73m and a secondary refrigerant passage switch valve 73n. The main refrigerant passage switch valve 73m is used to switch the refrigerant flow passage 72 between the compressor 41 and the condenser 42, and the secondary refrigerant passage switch valve 73n is used to switch between the heating refrigerant flow passage 72a and the cooling refrigerant flow passage 72b in the refrigerant flow passage 72 on the indoor unit 71 side.

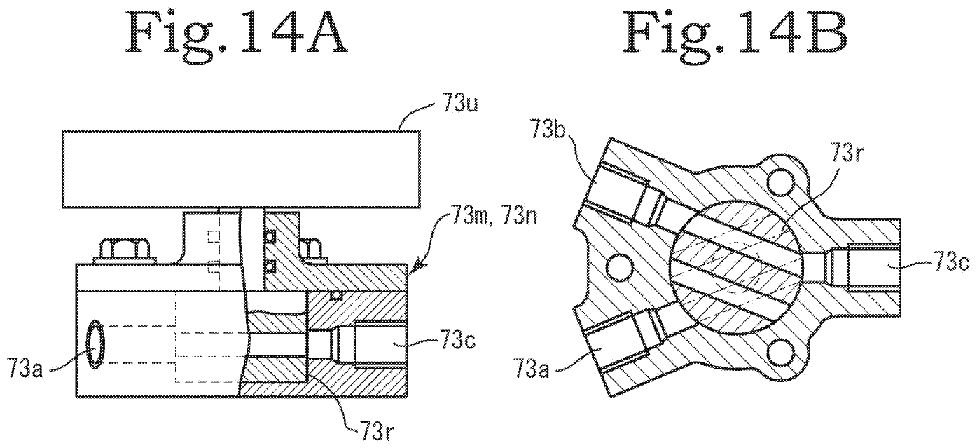

As shown in FIGS. 14A and 14B, the main refrigerant passage switch valve 73m and the secondary refrigerant passage switch valve 73n are structured substantially identically such that a rotary valve portion 73r is provided in the interior thereof, and by rotating the rotary valve portion 73r left and right, either a passage switching port 73c and a passage switching port 73a communicate with each other or the passage switching port 73c and a passage switching port 73b communicate with each other. This rotation is performed by an actuator 73u in response to a signal from the TCU (general controller) 66.

These switching positions realized by the TCU (general controller) 66 determine whether the air-conditioning system operates as a heating system or a cooling system. A command issued by the TCU (general controller) 66 is transmitted to an ECU (engine control unit) 67, and the ECU (engine control unit) 67 starts the gas engine 1 by means of a starter 11 using power from a battery 12. Further, the ECU (engine control unit) 67 controls operation variables such as the ignition timing, air-fuel ratio, and throttle opening of the gas engine 1. Thus, the throttle opening is adjusted so that the engine rotation speed of the gas engine 1 remains constant, and a fuel pressure adjuster is controlled so that the air-fuel ratio reaches the stoichiometric air-fuel ratio.

A heating operation performed by the gas engine air-conditioning device of the present invention will now be described on the basis of FIGS. 2 to 4. First, although it depends on the geographical region, generally, in buildings, the temperature difference between indoors and outdoors is greater in winter than in summer. An improvement in the heating performance is therefore desirable. A feature of the present invention is that the cooling water of the gas engine 1 and a part of the thermal energy dissipated inside of the housing are recovered.

First, under a command from the TCU (general controller) 66, the flow passage of the cooling water is switched by the water passage switch valve 53 so that the cooling water flows through the first cooling water circulation flow passage 51 (see FIG. 2). As for the refrigerant flow passage 72, the refrigerant flow passage 72 between the compressor 41 and the condenser 42 is switched by the main refrigerant passage switch valve 73m to the flow passage corresponding to heating, and the heating refrigerant flow passage 72a is selected by the secondary refrigerant passage switch valve 73n, whereby the refrigerant circulates through the refrigerant flow passage 72 by flowing through the heating refrigerant flow passage 72a (see FIGS. 2 to 4). The cooling water of the gas engine 1 flows through the first cooling water circulation flow passage 51 and is radiated into the atmosphere through a radiator core 61a of the first radiator 61, whereupon the cooling water is suctioned by a cooling water pump 13 and returned to a water jacket of the gas engine 1.

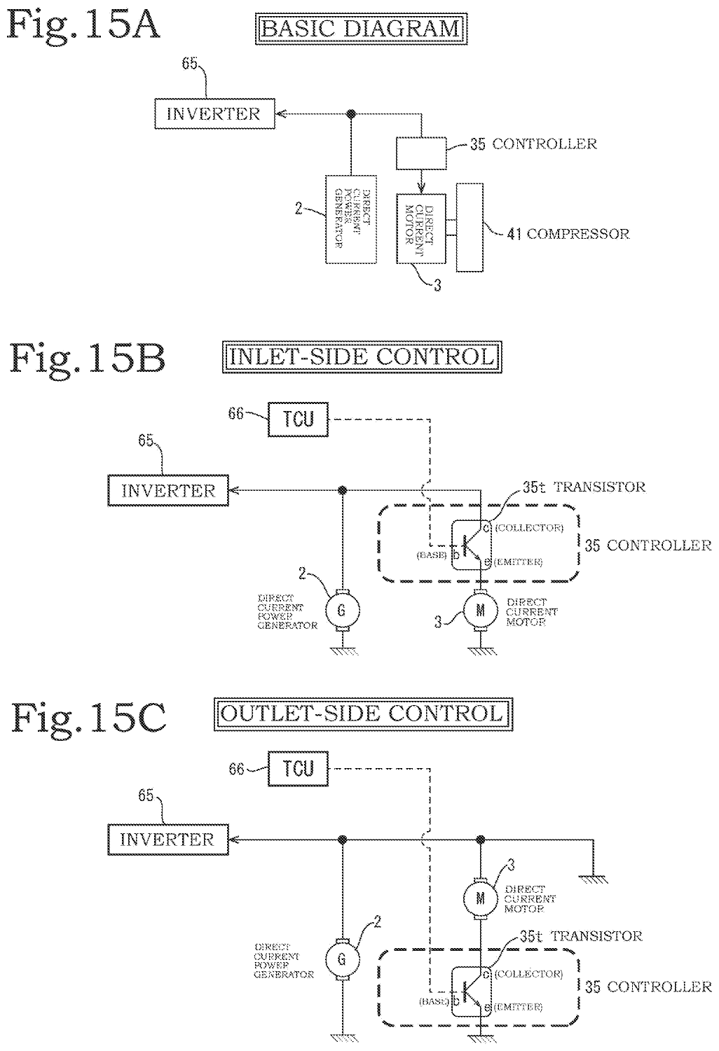

Power from the gas engine 1 drives the direct current power generator 2 via the coupling 14. Power generated by the direct current power generator 2 is supplied to the motor 3 via the controller 35 for controlling the output of the motor 3 (see FIG. 15A). In addition, surplus power generated by the direct current power generator 2 in accordance with the output of the gas engine 1 can be supplied to the outside as an alternating current power supply. More specifically, an inverter 65 is connected to the direct current power generator 2, and at the same time as power is supplied to the motor 3, the surplus power is transformed into predetermined power (100 V, 50 Hz, for example) by the inverter 65 and supplied to the outside as an alternating current power supply (see FIGS. 1A and 1B to 8 and so on).

As a specific example of the controller 35, a type that performs current control at the inlet or the outlet of the motor 3 may be used. In this specific example, a large-current transistor 35t is used on the inlet side or the outlet side of the motor 3. FIG. 15B shows inlet-side control, in which the controller 35 is provided on the inlet side of the motor 3. FIG. 15C shows outlet-side control, in which the controller 35 is provided on the outlet side of the motor 3.

In the inlet-side control, when the output of the motor 3 is to be increased, a command is issued from the TCU (general controller) 66 to the controller 35 to increase the current flowing from a b point (the base) to an e point (the emitter) of the controller 35. Accordingly, the current flowing through a c point (the collector), a b point (the base), and an e point (the emitter) of the transistor 35t increases greatly, leading to an increase in the output of the motor 3 and an increase in the heating or cooling capacity. Since the outlet-side control exhibits substantially identical actions to the inlet-side control, please refer to the inlet-side control.

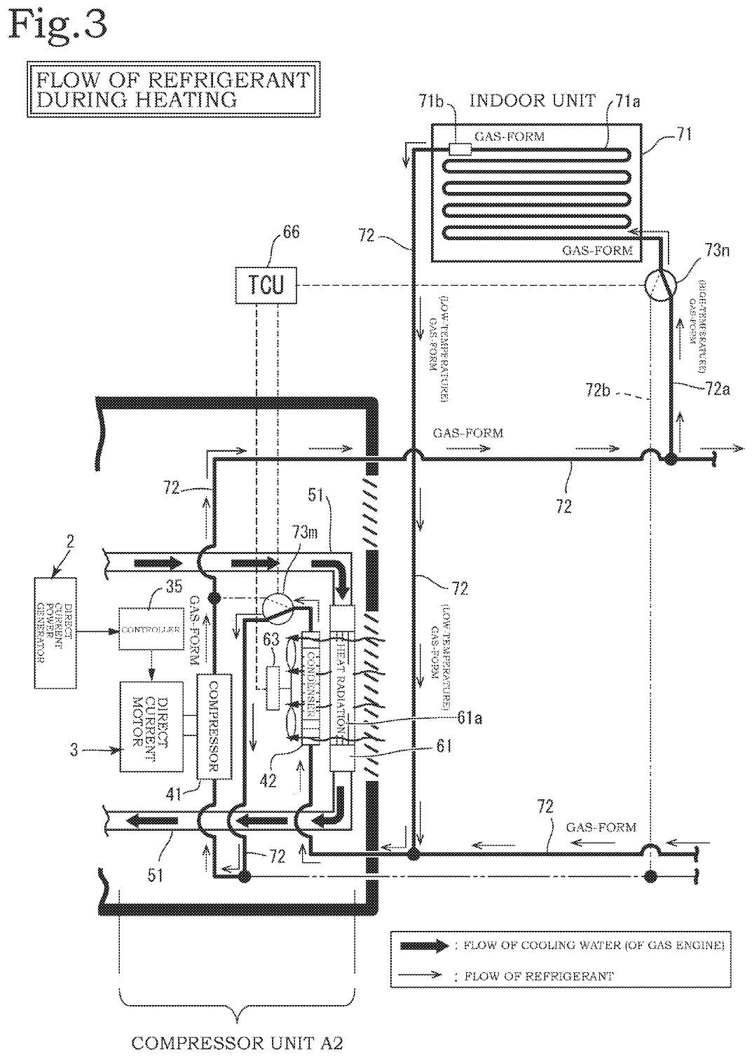

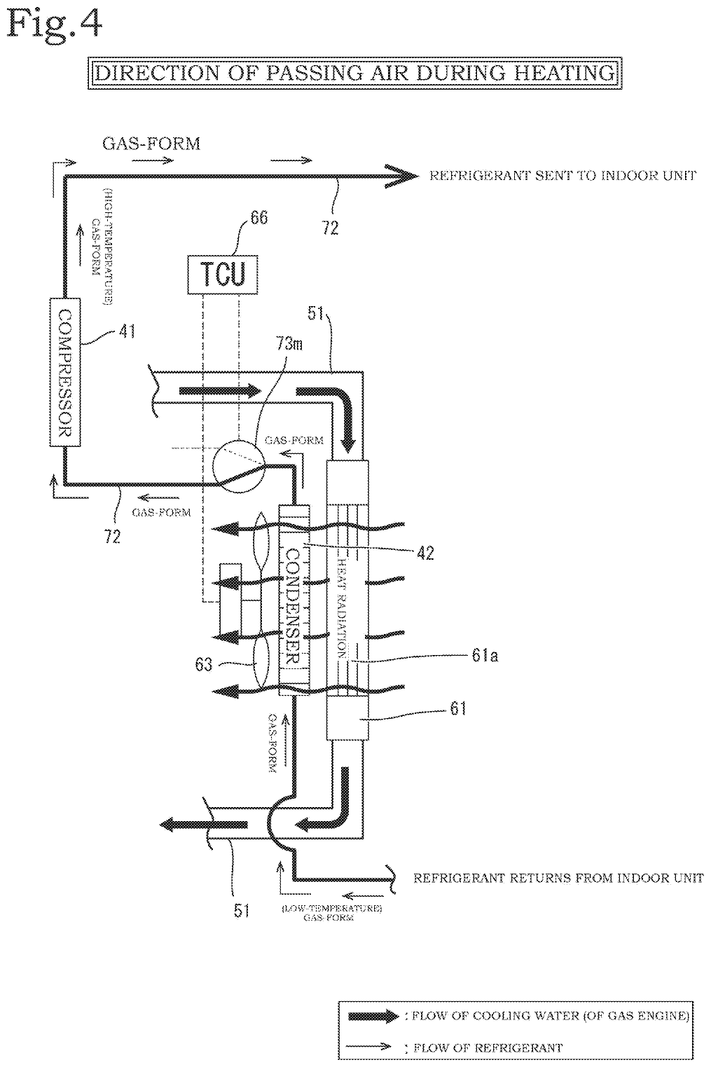

The engine cooling water flows through the core 61a of the first radiator 61 in the first cooling water circulation flow passage 51 and is radiated by the first radiator 61 (see FIGS. 3 and 4). As shown in FIGS. 3 and 4, high-temperature, high-pressure refrigerant gas from the compressor 41 is emitted from the top of the compressor 41 in the figures and returns downward.

By switching the secondary refrigerant passage switch valve 73n, the refrigerant in a high-temperature, high-pressure gas state is switched to the heating refrigerant flow passage 72a side, which is in a shut-off state, and flows through the heating refrigerant flow passage 72a. At this time, the refrigerant cannot pass through the cooling refrigerant flow passage 72b of the refrigerant flow passage 72. In the heating refrigerant flow passage 72a, as shown in FIGS. 2 to 4, the refrigerant flows as shown by the arrows illustrated in the refrigerant flow passage 72 so as to pass through the secondary refrigerant passage switch valve 73n and then pass through a core 71a of the indoor unit 71, whereby heat is released into the room (see FIGS. 2 and 3).

At this time, the temperature and pressure of the refrigerant gas both remain high until the refrigerant reaches an expansion valve 71b, and after passing through the expansion valve 71b, the temperature and pressure decrease such that the temperature naturally falls below the outside air temperature. The refrigerant then passes through the refrigerant flow passage 72 as shown by the arrows and enters a suction port (the lower side) of the condenser 42. Here, the refrigerant receives heat and is suctioned from the lower side of the compressor 41 through the main refrigerant passage switch valve 73m. Note that the refrigerant is suctioned from the lower side of the compressor 41 in a similar manner during cooling.

Here, the first fan 63 rotates in a direction for suctioning outside air into the general housing 9 in response to a command from the TCU (general controller) 66 (see FIGS. 2 to 4). The air that enters the general housing 9 from the outside passes through the radiator core 61a of the first radiator 61 as passing air, whereupon the warmed passing air passes through the condenser 42 so as to warm the condenser 42, and as a result, a larger amount of heat can be applied to the refrigerant in the condenser 42 than when the refrigerant is heated by outside air alone (see FIGS. 2 and 3). The refrigerant heated in the condenser 42 passes through the main refrigerant passage switch valve 73m so as to return to the suction (inlet) side of the compressor 41. The refrigerant is then compressed by the compressor 41 so as to reach an even higher temperature and exhibit a heating action, and as will be described below, when the temperature of the refrigerant gas that returns to the suction side of the compressor 41 increases, a further improvement in the heating performance is achieved.

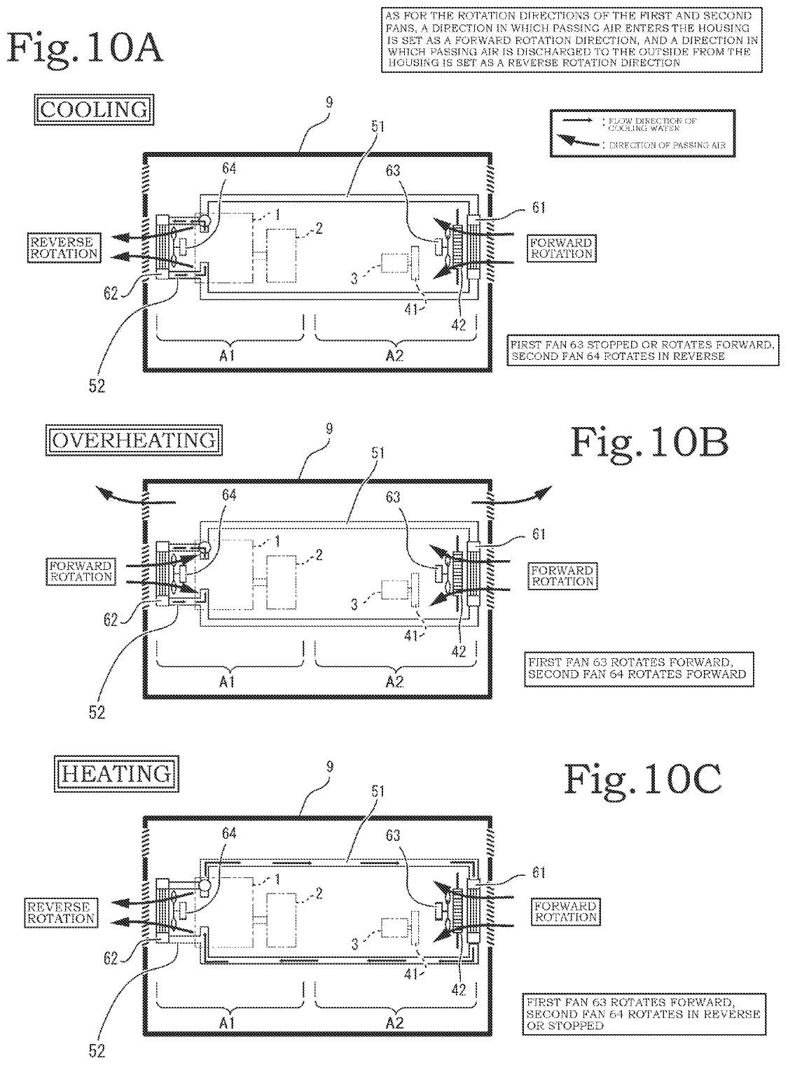

Moreover, here, by rotating the second fan 64 on the power unit A1 side in a direction for causing the passing air to flow from the inside of the general housing 9 toward the outside so as to be discharged, the second fan 64, together with the first fan 63, increases the amount of air passing through the condenser 42, leading to a further improvement in the heating effect (see FIG. 10B). Note that during heating, as described above, the water passage switch valve 53 is switched so that the entire amount of the engine cooling water flows through the radiator core 61a of the first radiator 61, and therefore a radiator core 62a of the second radiator 62 does not function. The passing air from the first fan 63 and the second fan 64 does not hinder cooling of the gas engine 1.

Here, the manner in which increasing the refrigerant gas temperature on the inlet side of the compressor 41 contributes to an increase in the temperature on the outlet side will be described. When gas having a volume Vin on the inlet side is compressed by the compressor 41 to Vout (Vin>Vout) in accordance with the laws of thermodynamics and the pre-compression (inlet) gas temperature is set as TinK (Kelvin) and the post-compression (outlet) temperature is set as ToutK, the following is established.

Tout=Tin(Vin/Vout)ⁿ⁻¹ K (Kelvin)

The value “n”, for which, in the case of adiabatic compression, the character “K (kappa)” may also be used, is unique to the gas. For example, monatomic molecule helium is 1.66, and air, which is a mixed gas of diatomic molecules, is 1.4. The value decreases as the number of atoms constituting the molecule increases. Note that in the case of isothermal compression, n=1 regardless of the type of gas. Hereafter, the n value of the refrigerant gas will be described as 1.07.

It is assumed that in the compressor 41, the refrigerant is compressed to a volume of 1/20. Tin is set at a temperature of 5° C. (278 K), which is close to the limit at which a heat pump can be operated, whereupon Tin is compared with the outlet temperature Tout in a case where the refrigerant is heated to 30° C. (303 K), as in the present invention.

In the case of 5° C.

Tout=278×20^{1.07-1}=342 K (69° C.)

In the case of 30° C.

Tout=303×20^{1.07-1}=374 K (101° C.)

Thus, a difference of 32° C. occurs in the temperature of the heat source used for heating. Note that this difference increases as Vin/Vout increases.

Next, the cooling operation will be described on the basis of FIGS. 5 to 7. During cooling, the second cooling water circulation flow passage 52 is selected by the water passage switch valve 53 so that no cooling water flows through the first cooling water circulation flow passage 51. In other words, when the second cooling water circulation flow passage 52 is selected by the water passage switch valve 53 during cooling, the cooling water forms a flow that flows through and around the gas engine 1 and cools only the gas engine 1.

Further, as regards the refrigerant flow passage 72, the refrigerant flow passage 72 between the compressor 41 and the condenser 42 is switched by the main refrigerant passage switch valve 73m to the flow passage corresponding to cooling, and the cooling refrigerant flow passage 72b is selected by the secondary refrigerant passage switch valve 73n, whereby the refrigerant circulates through the refrigerant flow passage 72 by flowing through the cooling refrigerant flow passage 72b (see FIGS. 5 to 7). The compressor 41, which is driven by the motor 3, compresses the gas-form refrigerant (which may also contain a small amount of liquid), whereupon the refrigerant, which has turned into high-temperature gas, passes through the main refrigerant passage switch valve 73m, which is set in the switch position shown in FIGS. 5 to 7, and enters the condenser 42. Here, the refrigerant radiates heat so that the temperature thereof decreases, and as a result turns into liquid-form (including gas-form). The refrigerant is then vaporized and expanded all at once while passing through the expansion valve 71b of the indoor unit 71, and as a result, the temperature thereof decreases greatly, whereupon the core 71a removes heat from the air in the room, leading to a reduction in the room temperature.

The gas-form refrigerant expanded in the indoor unit 71 then returns to the suction side of the compressor 41 through the cooling refrigerant flow passage 72b selected by the secondary refrigerant passage switch valve 73n (see FIGS. 5 to 7). Thus, during cooling, the first cooling water circulation flow passage 51 is blocked by the water passage switch valve 53 such that no cooling water flows through the first cooling water circulation flow passage 51. Accordingly, the cooling water does not pass through the first radiator 61 and does not warm the condenser 42 or the refrigerant in the condenser 42. Furthermore, by rotating the second fan 64, which is capable of forward and reverse rotation, so as to suction outside air, the first radiator 61 is cooled and the amount of air passing through the radiator core 61a is increased, which is useful for cooling the engine during cooling.

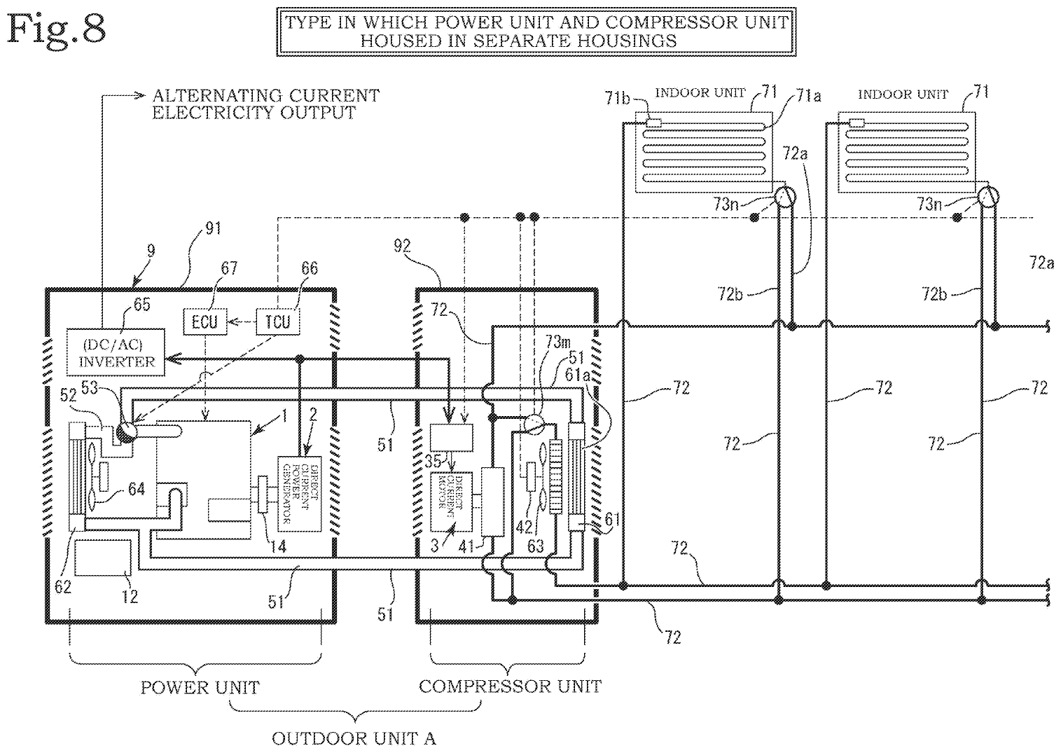

In FIGS. 1A, 2, and 5, the outdoor unit A is formed by housing the power unit A1 and the compressor unit A2 in the single general housing 9. In another embodiment (see FIG. 8), however, the general housing 9 is divided into two housings, namely a first housing 91 and a second housing 92. A power supply system that includes the gas engine 1, the direct current power generator 2, the TCU (general controller) 66, the ECU (engine control unit) 67, the second cooling water circulation flow passage 52, the second radiator 62, and the second fan 64, which together constitute the power unit A1, is housed in the first housing 91. Further, the motor 3, the controller 35, the compressor 41, the condenser 42, the first radiator 61, and the first fan 63, which together constitute the compressor unit A2, are housed in the second housing 92. The first housing 91 and the second housing 92 are connected only by the first cooling water circulation flow passage 51, a signal line, and a cable for transmitting the power generated by the direct current power generator 2, and the air-conditioning refrigerant flow passage (refrigerant piping) 72 is provided only in the second housing 92.

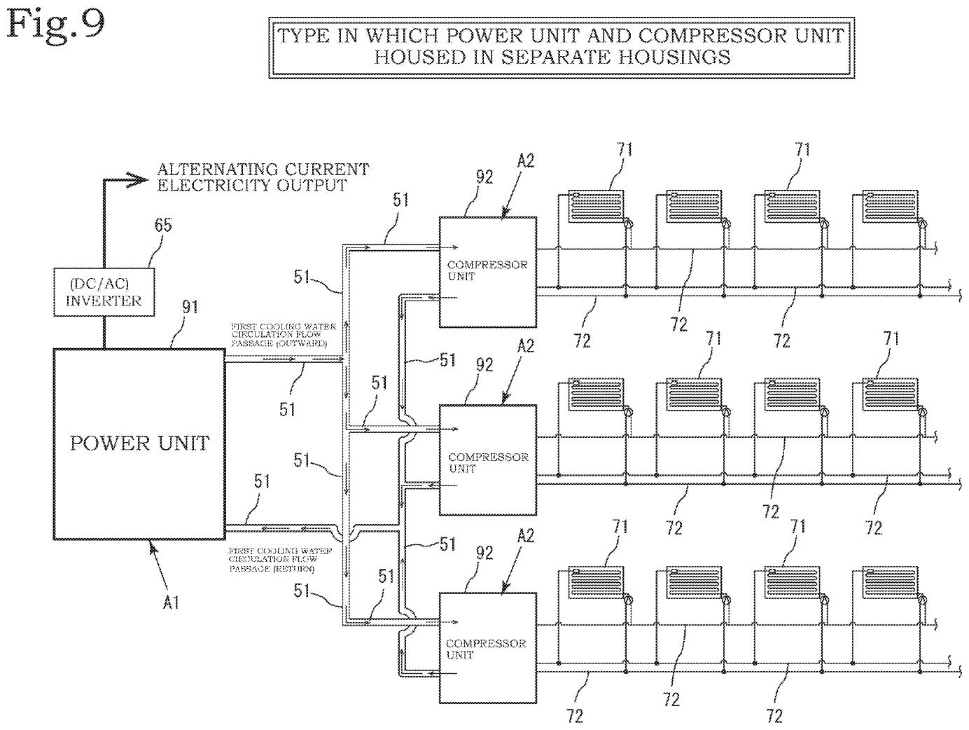

When this configuration, in which the power unit A1 and the compressor unit A2 are divided and housed respectively in the first housing 91 and the second housing 92, is employed, as long as the gas engine 1 on the power unit A1 side has a power surplus and sufficient electric power, the power unit A1 housed in the first housing 91 may be provided singly and compressor units A2 housed in a plurality of second housings 92 may be arranged and operated in parallel (see FIG. 9). When this configuration is employed, the following advantage is gained.

The gas engine air-conditioning device can be installed extremely efficiently as an air-conditioning facility for a building with many rooms or a multi-story building. The first housing 91 housing the power unit A1 is used as a main device, and the single power unit A1 is installed indoors in a main power room of the building or an engine room in the basement or the like (see FIG. 9). The second housing 92 housing the compressor unit A2 is provided in a plurality, and the plurality of second housings 92 are arranged in parallel, one on each floor. By installing the compressor units A2 housed respectively in the second housings 92 on each floor and making each compressor unit A2 responsible for a plurality of indoor units installed on each floor, the power generated by the power unit A1 housed in the first housing 91 can be used extremely effectively, whereby the air-conditioning facility can be realized at low cost. Note that the first housing 91 may also be installed on the outside of the building.

Power is supplied to the outside by the inverter 65 of the power unit A1 in the first housing 91 (see FIGS. 1A and 1B). Specifically, a DC/AC (direct current/alternating current) inverter is used as the inverter 65. Further, the inverter may also be referred to as a converter. By installing the first housing 91 housing the power unit A1 in a basement or on a roof and arranging the second housing 92 housing the compressor unit A2 on each floor or in each building, the refrigerant flow passage (refrigerant piping) 72 from each second housing 92 to each indoor unit 71 can be shortened, and heat exchange between the refrigerant and the atmosphere in the refrigerant flow passage (refrigerant piping) 72 can be reduced, enabling an improvement in the air-conditioning performance.

Next, a specific example of a relationship between the thermal efficiency of the gas engine air-conditioning device according to the present invention and the overall thermal efficiency of a heat pump system will be described. This relationship is calculated using 20 kW as the output of the gas engine 1, 5 kW as the surplus power (the power supplied to the outside), and 95% as each of the generation efficiency and the inverter efficiency. Here, to simplify the description, it is assumed that the 5 kW includes the less than 1 kW of power that is consumed by the electric fans in the housing and the control.

When the engine output is set at 20 kW,
5.54 kw (5 kw×1/0.95×1/0.95) . . . power supplied to outside
14.46 kw (20 kw−5.54 kw) . . . heat pump power
is obtained.

Assuming that the efficiency of the controller 35 of the direct current motor 3 is 95%, of this power, the power that can be consumed by the motor is 14.46 kW×0.95=13.74 kW. Since waste heat is recovered, a COP (coefficient of performance) of 5.5 or more can be secured even in the case of heating. The thermal energy that can be used for heating, which is acquired with the aforementioned power of 13.74 kW, is 13.74×5.5=75.57 kW.

Accordingly, (thermal energy during heating)+(power supplied to outside)−80.57 kW

Meanwhile, when the thermal efficiency of the engine is set as 11E, the energy Qf of the fuel is

Qf=20 kW/ηE.

Accordingly, the overall thermal efficiency ηT is

ηT=80.57 kW/(20 kW/ηE)≈4ηE (1)

When rapid combustion and cooling loss are taken to the limit and full use is made of the inertial intake/exhaust phenomenon, a thermal efficiency of 44% or more is achieved even in a case where the gas engine 1 is operated at the stoichiometric air-fuel ratio in order to operate a three-way catalyst 16k. Furthermore, when the normal engine rotation speed is suppressed to or below 2400 rpm, friction loss can be kept to or below 7%, and therefore the mechanical efficiency of the engine equals or exceeds 93%. Hence, the thermal efficiency of the engine is

ηE=44×0.93 40.92% (2)

From equation (1) and equation (2), ηT≥4×0.4=1.6

In other words, the overall thermal efficiency is 160%. If all of the power generated by the direct current power generator 2 is used to drive the compressor 41, an overall thermal efficiency of 200% or more can be realized in this system.

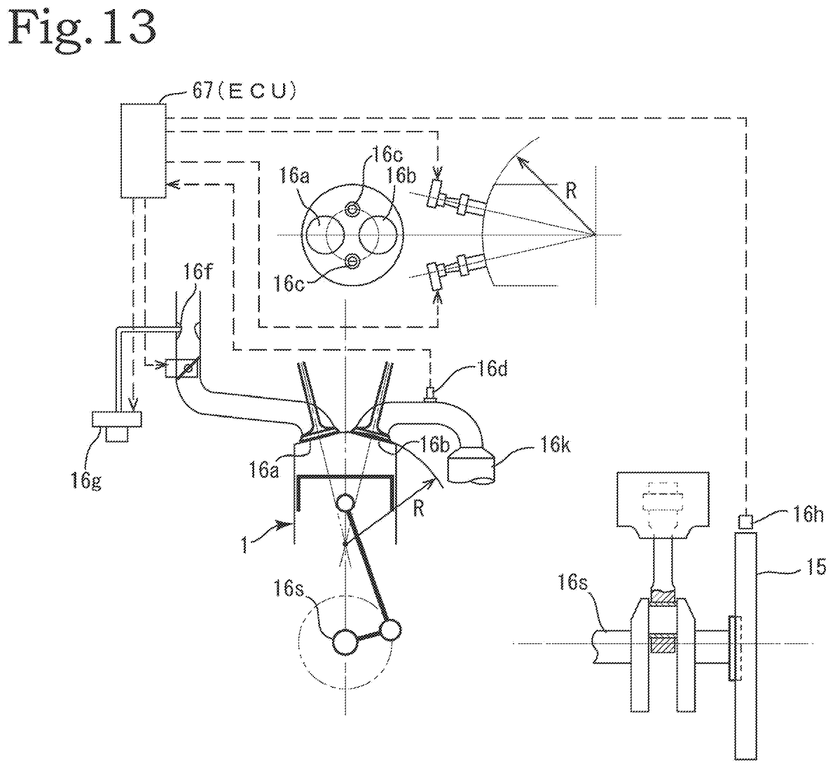

As described above, in order to achieve a higher indicated thermal efficiency than that of lean burn or divided-chamber even when the gas engine 1 is operated at the stoichiometric air-fuel ratio in order to operate the three-way catalyst 16k, as shown in FIG. 13, the surface area of the combustion chamber is reduced and simultaneous ignition is performed from two locations so as to shorten the flame propagation distance, and moreover, due to flame reflection, the gas temperature of the unburned part increases, leading to an increase in the propagation speed of the flame.

In the gas engine 1, the combustion chamber is formed in point symmetry about a cylinder, an intake valve 16a and an exhaust valve 16b have identical (substantially identical) umbrella diameters, and two spark plugs 16c are also arranged symmetrically. Centers of these components are located on a circumference of ½ the cylinder diameter. Furthermore, extension lines of center lines thereof intersect at a 0 point on a center line of the cylinder. The combustion chamber is a thin spherical shell with a radius R centering on the 0 point, and an ignition point and umbrella portions of the intake valve 16a and the exhaust valve 16b substantially extend along the spherical shell.

Further, the air-fuel ratio is set at the stoichiometric air-fuel ratio by a signal from an O2 sensor 16d mounted on the exhaust system by adjusting the pressure of gas fuel supplied to a mixer 16f using a fuel pressure adjuster 16g. The rotation speed of a crankshaft 16s is detected by an engine rotation sensor 16h disposed near a flywheel 15, and when the load of the gas engine 1 increases such that the rotation speed decreases, the throttle opening is adjusted so as to achieve a predetermined rotation speed (2200 rpm, for example) (see FIG. 13). When the rotation speed is high, the throttle is moved in a closing direction.

In order to reduce friction loss, rather than lengthening the stroke, the stroke is set at the cylinder diameter, as shown in the figure, or slightly longer, and rather than pursuing an increased compression ratio (12 or more) simply by increasing the stroke, this is realized by the compact combustion chamber described above. The rotation speed, the air-fuel ratio, the ignition timing, starting and stopping of the engine, and so on are all controlled by the ECU (engine control unit) 67. Variation occurs in the engine rotation speed due to torque variation generated in each of the intake, compression, expansion, and exhaust strokes. Even if this rotation speed variation is slight (for example, 1/50), the generation efficiency is impaired thereby. Therefore, the coupling 14 is interposed between the flywheel 15 and the direct current power generator 2 in order to smooth vibration in the rotation direction.

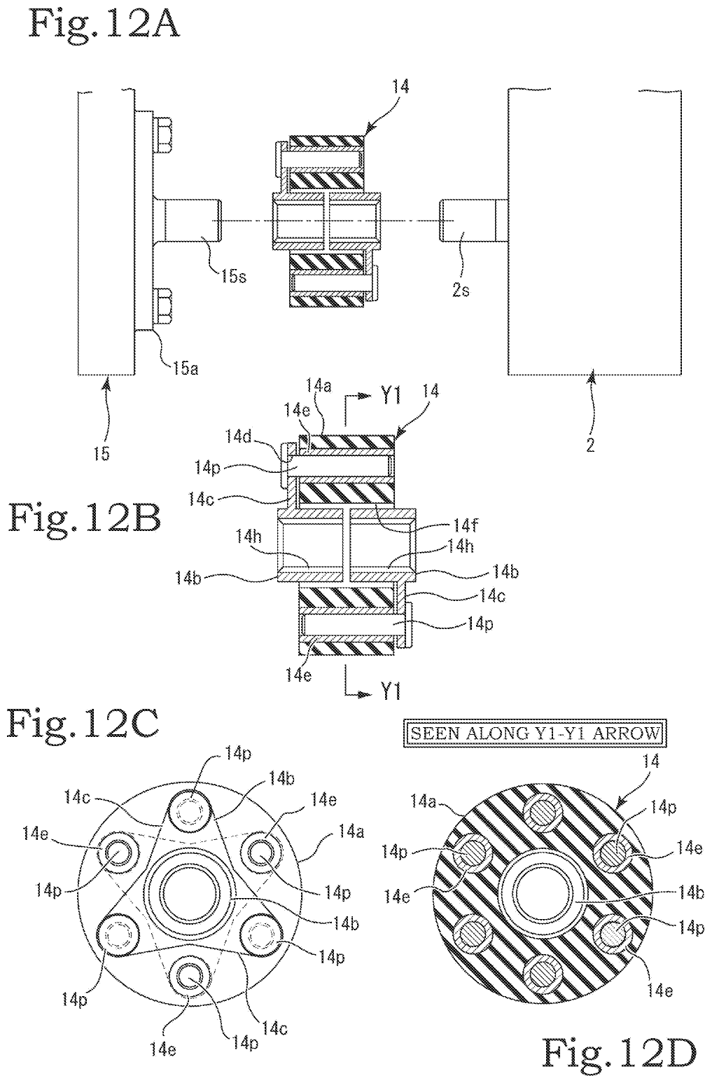

Next, a structural example of the coupling 14 connecting the gas engine 1 to the direct current power generator 2 will be described. As shown in FIGS. 12A to 12D, the coupling 14 is constituted by a buffer member 14a, two flanges 14b, and pins 14p. The flanges 14b are substantially Y-shaped members (see FIG. 12C), and in a central portion thereof, spline hubs 14h are formed at 120-degree intervals around a circumferential direction as female splines. Further, three arm-shaped pieces 14c are arranged in radial form with the spline hubs 14h serving as the diametrical center thereof, and connecting holes 14d through which the pins 14p are inserted are formed in the tip ends of the arm-shaped pieces 14c.

The buffer member 14a is substantially cylindrical and is formed from an elastic material such as rubber, synthetic resin, or the like, for example (see FIG. 12D). A through hole 14f is formed in the diametrical center of the buffer member 14a so as to extend in an axial direction, and the spline hubs 14h of the flanges 14b are inserted with play into the through hole 14f. Here, inserted with play means that the spline hubs 14h are inserted into the through hole 14f so as to leave a gap, whereby the spline hubs 14h have a certain amount of play and can move within the through hole 14f. Furthermore, six tubular sleeves 14e are arranged in the buffer member 14a at equal intervals (60 degrees) so as to extend in the axial direction near the outer peripheral edge. The pins 14p are inserted into the sleeves 14e in a press-fitted state.

The flanges 14b are arranged on the two axial direction ends of the buffer member 14a so as to face each other. At this time, the arm-shaped pieces 14c of the two flanges 14b are not phase-aligned and are arranged so as to deviate by 60 degrees. Three pins 14p are arranged at 120-degree intervals near the outer periphery of the spline hubs 14h of the respective flanges 14b, and the pins 14p are inserted into the connecting holes 14d in the tip ends of the arm-shaped pieces 14c and inserted into the sleeves 14e provided in the buffer member 14a so as to connect the buffer member 14a and the flanges 14b. Thus, the coupling 14 is used as a flange joint that is capable of elastic deflection in the axial direction.

Meanwhile, an adapter 15a provided with a male spline 15s in the center thereof is fixed by a bolt to the flywheel 15 mounted on the gas engine 1. Further, the direct current power generator 2 includes a male spline 2s. The spline 15s of the flywheel 15 and the spline 2s of the direct current power generator 2 are inserted into the spline hubs 14h on the two axial direction sides of the coupling 14 so that the gas engine 1 and the direct current power generator 2 are capable of rotary drive transmission. The torque of the gas engine 1 is smoothed and transmitted to the direct current power generator 2 from the spline 2s on the direct current power generator 2 side through the buffer member 14a of the coupling 14.

In the present invention, instead of using an intermediate refrigerant such as water, the gas-form refrigerant (a very small part of which may be in liquid-form) that has only just been pressurized by and discharged from the compressor 41 is directly circulated.

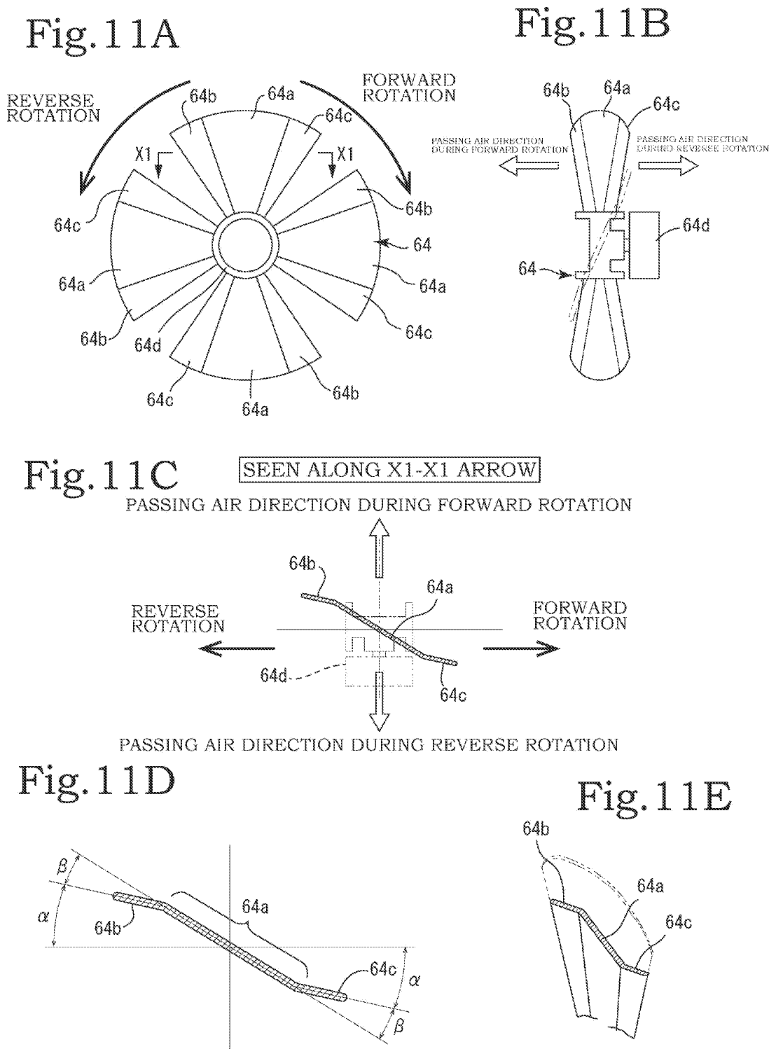

The present invention includes an embodiment (see FIGS. 11A to 11E) in which the second fan 64 that sends passing air to the second radiator 62 is configured to be capable of changing the direction of the passing air sent to the second radiator 62. In this embodiment, the direction of the passing air sent to the second radiator 62 can be switched between forward and reverse by rotating a propeller of the second fan 64 either forward or in reverse. Thus, during cooling in summer, the power unit A1 can be prevented from overheating and damaging the device.

The following situation is particularly likely to occur in summer. First, the output of the engine decreases due to a reduction in the density of the intake air. Next, in the case of a spark ignition engine, the engine may be damaged due to the occurrence of knocking. Next, the power generation efficiency and the conversion efficiency of the inverter decrease due to overheating of the power generator. By rotating the second fan 64, which is capable of rotating forward and in reverse, either forward or in reverse in accordance with the situation, as described above, the flow of air through the general housing 9 can be controlled, and as a result, the problematic situation described above can be resolved, making it possible to maintain the environment inside of the general housing 9 in a favorable state (see FIGS. 10A to 10C).

First, the temperature of the housing (the general housing 9, the first housing 91, or the second housing 92) is detected, and when the temperature reaches 60° C., the second fan 64 is switched from forward rotation to maximum reverse rotation by a command from the TCU (general controller) 66, whereby outside air flows into the housing and cools the interior of the housing. Furthermore, the second fan 64 includes a plurality of blades, and each blade has a flat plate-shaped blade central portion formed in an intermediate location along the rotation direction and blade end portions formed on the two ends of the blade at the two rotation direction ends of the blade central portion, and attack angles of the two blade end portions are set to be identical and smaller than the attack angle of the blade central portion.

The second fan 64, which is capable of forward and reverse rotation, used in the gas engine air-conditioning device of the present invention will now be described. In the second fan 64, an electric motor is used as a drive source so that forward and reverse rotation can be performed simply, without using a gear or the like. In order to improve the efficiency of a conventional fan, the blades of the fan are cambered (arc-shaped, for example). Thus, the efficiency when the fan is rotated rightward (in a forward direction) as seen from the front is improved in comparison with a flat plate shape such as that of a paper fan. In the case of reverse rotation, however, a problem arises in that the amount of wind decreases.

In the second fan 64 shown in FIGS. 11A to 11E, on the other hand, when flat plates are combined, the attack angle is the same during both forward rotation and reverse rotation, and therefore the same amount of wind is obtained during both forward and reverse rotation, which is optimal for the present invention. Next, actions will be described. Each blade is assumed to be formed from a blade central portion 64a and blade end portions 64b and 64c. The part of the blade central portion 64a in the center has the same attack angle α+β during both forward and reverse rotation. During forward rotation, the blade end portion 64c forms the front edge, and since the attack angle of this part is a, which is smaller than the attack angle of the blade central portion 64a by R, a collision between the blade and the air is alleviated. Furthermore, in FIGS. 11A to 11E, a reference symbol 64d denotes a fan motor for rotating the blades.

Further, the blade end portion 64b forms the rear edge, and since the angle thereof is smaller than the blade central portion 64a, a vortex generated on the back surface is reduced. By folding the blade into three parts in this manner, the blade more closely resembles a blade of a camber wing than a paper fan-type blade. In the case of reverse rotation, the blade end portion 64b forms the front edge and the blade end portion 64c forms the rear edge, meaning that the shape is identical to that realized during forward rotation, and therefore, although the blade falls short of a camber wing during forward rotation, the same amount of wind can be secured during both forward and reverse rotation. The forward rotation direction is set as the rotation direction of the second fan 64 so that the passing air enters the general housing 9 from the outside of the general housing 9. Further, the reverse rotation direction is set as the rotation direction of the second fan 64 so that the passing air exits the general housing 9 from the inside of the general housing 9.

The rotation directions of the first fan 63 and the second fan 64 during cooling, overheating, and heating will now be described. During cooling, overheating, and heating, the first fan 63 is always operated in the forward rotation direction so that the passing air enters the general housing 9 from the outside of the general housing 9. The second fan 64 is structured to be capable of rotating both forward and in reverse. During cooling, as shown in FIG. 10A, the passing air flows in one direction through the general housing 9 from the first radiator 61 side toward the second radiator 62 side. When rotated in reverse, the second fan 64 acts to discharge the passing air from the inside of the general housing 9 to the outside of the general housing 9. Since cooling is underway, no cooling water circulates through the first cooling water circulation flow passage 51 and the first radiator 61.

During overheating, as shown in FIG. 10B, powerful ventilation is required in the interior of the general housing 9. Accordingly, ventilation is performed by the first fan 63 and the second fan 64 by blowing passing air into the general housing 9. The first fan 63 and the second fan 64 both rotate strongly forward. At this time, no cooling water circulates through the first cooling water circulation flow passage 51 and the first radiator 61.

During heating, as shown in FIG. 10C, a strong flow of passing air flows through the general housing 9 from the first radiator 61 side toward the second radiator 62 side. The second fan 64 is either rotated in reverse or stopped. Since heating is underway, cooling water circulates through the first cooling water circulation flow passage 51 and the first radiator 61.

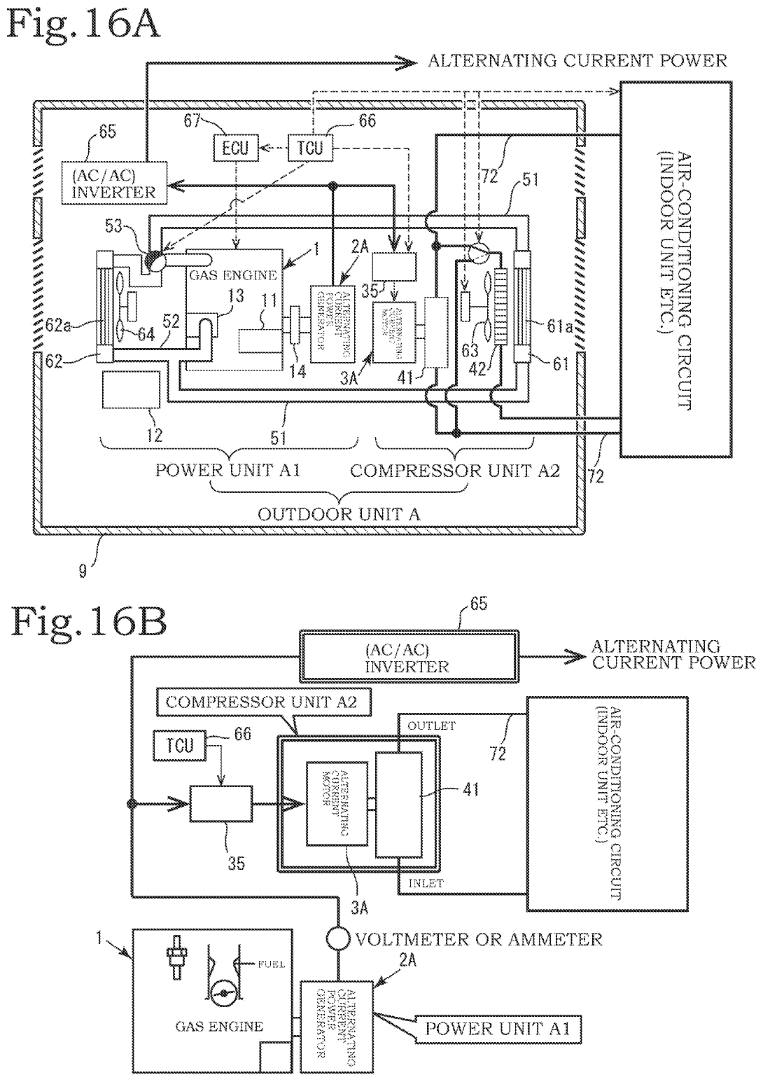

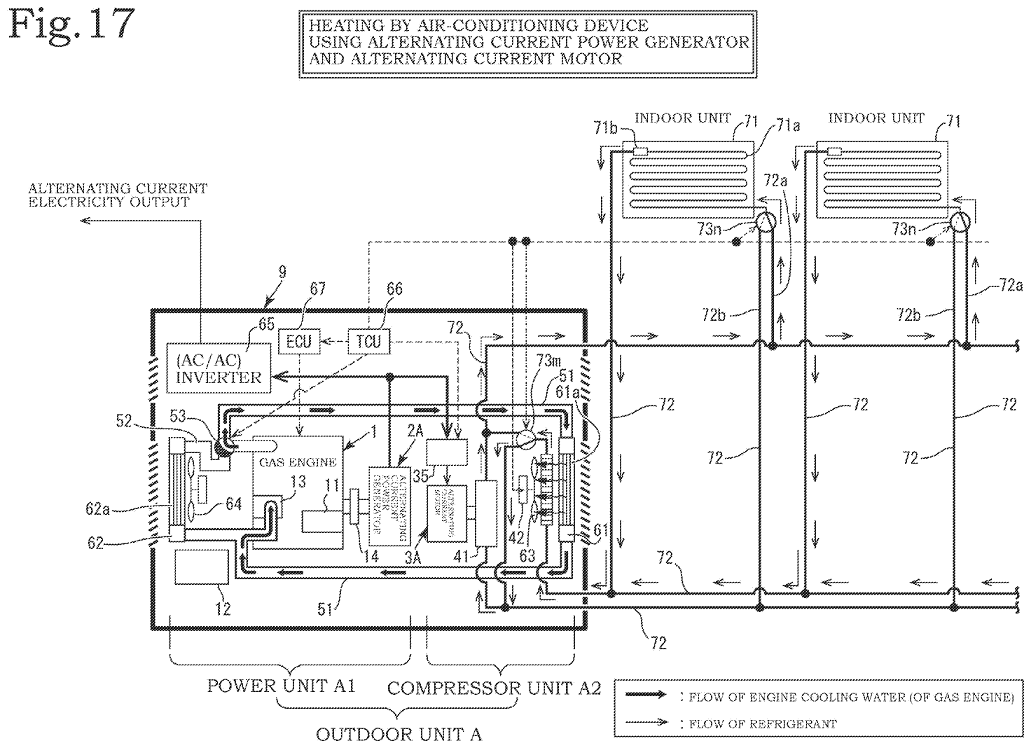

A case in which a direct current motor is used as the motor 3 was described above. Next, an embodiment in which an alternating current motor 3A is used as the motor 3 will be described on the basis of FIGS. 16A and 16B to 18A and 18B. In this embodiment, an alternating current power generator 2A is used instead of the direct current power generator 2 and, as noted above, the alternating current motor 3A is used as the motor 3 (see FIGS. 16A and 16B to 18A and 18B). The configurations and arrangements of equipment such as the gas engine 1, the first cooling water circulation flow passage 51, the second cooling water circulation flow passage 52, the compressor 41, and the condenser 42 and the actions of the cooling water and the refrigerant during heating and cooling are identical to the configurations and the actions of the cooling water and the refrigerant during heating and cooling in the embodiment using the direct current power generator 2 and the direct current motor 3, described above. Accordingly, please refer to FIGS. 2 to 7. In this embodiment, the alternating current power generator 2A uses the gas engine 1 to deliver an alternating current to an alternating current controller 35A.

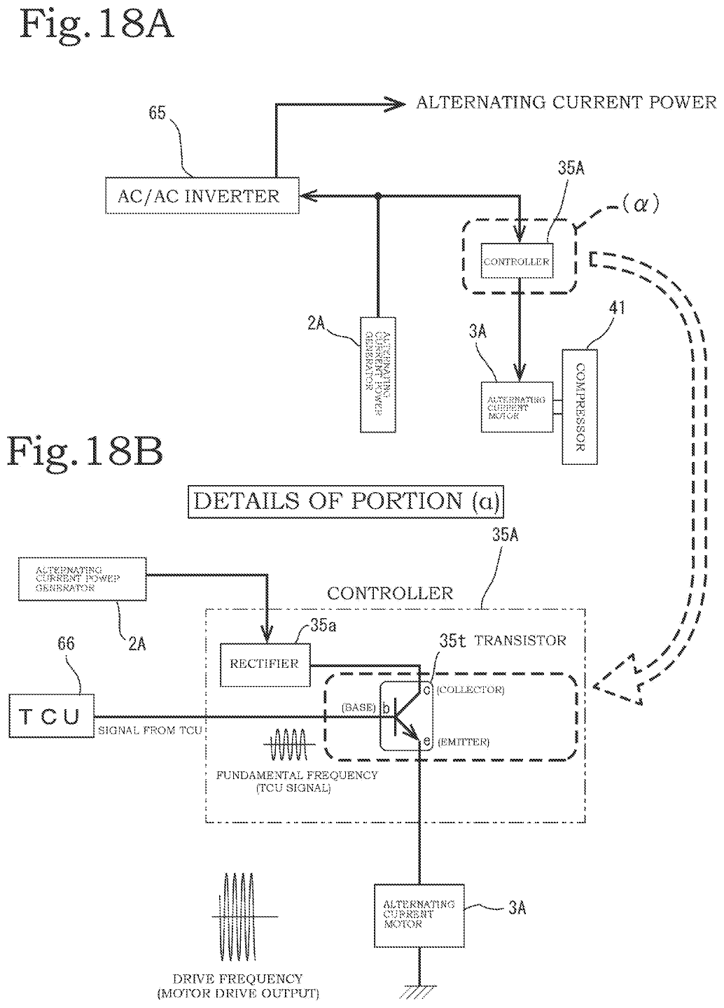

The alternating current controller 35A differs from the controller corresponding to the direct current motor 3, and therefore the controller corresponding to the alternating current motor 3A will now be described. The controller 35A includes a rectifier 35a. When current is delivered from the alternating current power generator 2A to the alternating current motor 3A, the rectifier 35a functions to adjust the current to a fundamental frequency that is suitable for the alternating current motor 3A (see FIGS. 18A and 18B).

Furthermore, this fundamental frequency must be amplified in order to drive the alternating current motor 3A. Accordingly, the alternating current of the fundamental frequency is transmitted to a large-capacity transistor 35t, and an alternating current signal for amplifying the fundamental frequency to the drive frequency required to operate the alternating current motor 3A is transmitted to the transistor 35t in response to a command from the TCU (general controller) 66 (see FIG. 18B).

The transistor 35t then amplifies the fundamental frequency generated by the rectifier to the drive frequency required to drive the alternating current motor 3A to rotate, and as a result, the alternating current motor 3A is driven. By increasing the rotation speed of the alternating current motor 3A using the drive frequency that has been increased above the fundamental frequency by the amplification amount in response to a command from the TCU (general controller) 66, the air-conditioning capacity can be increased.

Furthermore, by reducing the amount by which the fundamental frequency is amplified and setting the result as the drive frequency in response to a command from the TCU (general controller) 66, the air-conditioning capacity can be reduced, enabling energy saving. More specifically, when the output of the alternating current motor 3A is to be increased, a command is issued to the controller 35 from the TCU (general controller) 66 to increase the current flowing from the b point (the base) to the e point (the emitter) of the controller 35. Accordingly, the current flowing through the c point (the collector), the b point (the base), and the e point (the emitter) of the transistor 35t increases greatly, leading to an increase in the output of the alternating current motor 3A and an increase in the heating or cooling capacity.

In the embodiment of the air-conditioning device using the alternating current power generator 2A and the alternating current motor 3A, an AC-AC inverter is used as the inverter 65 (see FIG. 18A). The inverter 65 (the AC-AC inverter) functions to stabilize the high-voltage alternating current generated by the alternating current power generator 2A, and to adjust the alternating current so as to be used as a general alternating current power supply.

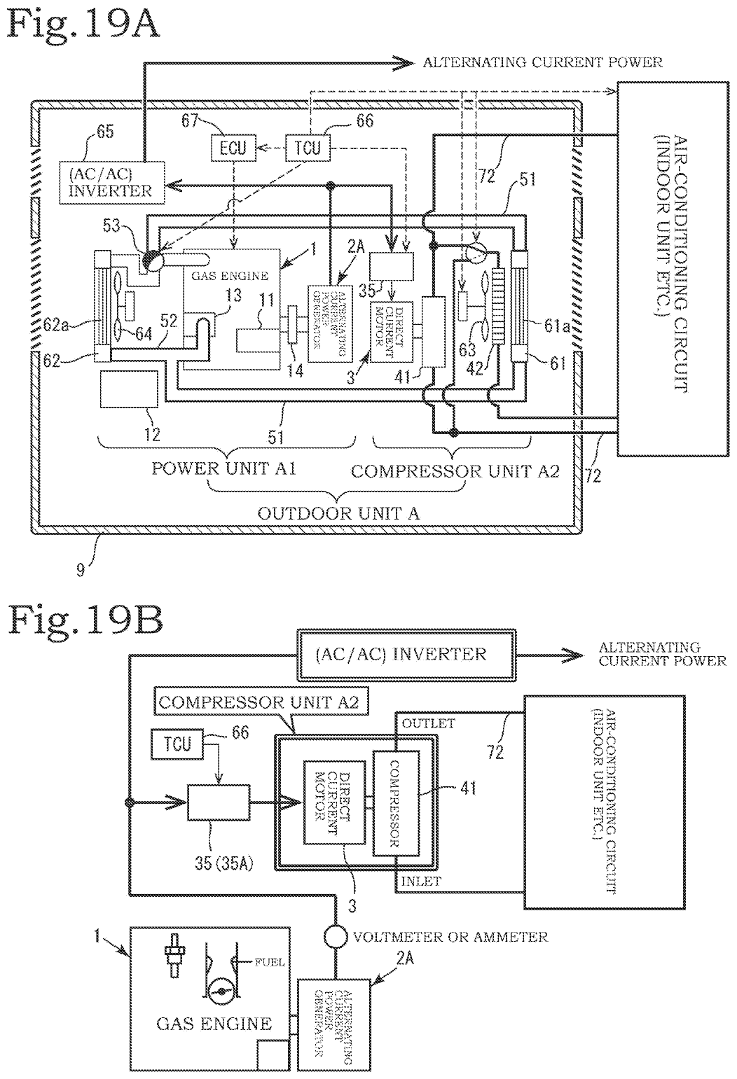

Further, FIGS. 19A and 19B shows an embodiment in which the alternating current power generator 2A is used as the power generator and a direct current motor is used as the motor 3. In this embodiment, as regards the alternating current power generated by the alternating current power generator 2A, the alternating current is converted into a direct current by the controller 35, whereupon electricity is transmitted to the direct current motor 3.

In the second aspect, the second fan is configured to be capable of changing the direction of the passing air sent to the second radiator, making it possible to manage the temperature in the housing that houses the equipment and thereby to prevent the outdoor unit from overheating at high temperatures during summer in particular. In the third aspect, the attack angle of the second fan during forward rotation and reverse rotation is the same, and in contrast to a normal fan, the wind direction is directly opposite during both forward and reverse rotation, meaning that the wind amount and the wind force can be made identical. As a result, air can be taken into and discharged from the housing evenly.

In the fourth, fifth, and sixth aspects, the ECU (engine control unit) and the TCU (general controller) are further provided, an assembly of the gas engine, the ECU, and the direct current power generator is housed in the first housing as the power unit, an assembly of the motor, the compressor, the condenser, the first radiator, and the first fan is housed in the second housing as the compressor unit, and the first cooling water circulation flow passage is provided between the first housing and the second housing so as to connect the first housing and the second housing. Thus, the gas engine air-conditioning device can be installed extremely efficiently as an air-conditioning facility for a building with many rooms or a multi-story building.

Furthermore, by using the first housing including the power unit as a main device and installing one first housing in the main power room of the building, and disposing the second housing including the compressor unit on each floor so that the second housings are arranged in parallel and making each second housing responsible for a plurality of indoor units installed on the corresponding floor, the power generated from the first housing including the power unit can be used extremely effectively, whereby an air-conditioning facility can be realized at low cost.

In the seventh aspect, a direct current motor is used as the motor, and a motor output control device is provided to supply appropriate power between the direct current power generator and the motor, enabling fine control over adjustments for driving of the motor and the compressor in the compressor unit. In the eighth aspect, by using an alternating current motor as the motor, maintenance can be performed easily and a low-cost facility can be realized.

1. A gas engine air-conditioning device comprising an outdoor unit that includes: a gas engine; a first cooling water circulation flow passage and a second cooling water circulation flow passage through which cooling water of the gas engine circulates; a first radiator provided in the first cooling water circulation flow passage; a second radiator provided in the second cooling water circulation flow passage; a water passage switch valve for circulating the cooling water through either the first cooling water circulation flow passage or the second cooling water circulation flow passage; a direct current power generator driven by the gas engine; a motor operated by the direct current power generator; a compressor driven by the motor to compress a refrigerant; a condenser for performing heat exchange on the refrigerant; a first fan provided on the first radiator side; and a second fan provided on the second radiator side, the gas engine air-conditioning device configured such that during heating, the cooling water is circulated through the first cooling water circulation flow passage by the water passage switch valve, high-temperature passing air is sent from the first radiator, which reaches a high temperature, to the condenser by the first fan, and the refrigerant compressed by the compressor is circulated to an indoor unit, and during cooling, the cooling water is caused to flow through the second cooling water circulation flow passage by the water passage switch valve, and surplus power generated by the direct current power generator in accordance with the output of the gas engine is supplied to the outside as an alternating current power supply.

2. The gas engine air-conditioning device according to claim 1, wherein the second fan is capable of changing a direction of passing air sent to the second radiator.

3. The gas engine air-conditioning device according to claim 2, wherein the second fan includes a plurality of blades, each blade has a blade central portion formed in an intermediate location along a rotation direction, the blade central portion having a flat plate shape and inclining along the rotation direction, and blade end portions formed on two rotation direction ends of the blade central portion so as to incline along the rotation direction, and attack angles of the two blade end portions are set to be identical and smaller than an attack angle of the blade central portion.

4. The gas engine air-conditioning device according to claim 1, further comprising an ECU and a TCU, wherein an assembly of the gas engine, the ECU, and the direct current power generator is housed in a first housing as a power unit, an assembly of the motor, the compressor, the condenser, the first radiator, and the first fan is housed in a second housing as a compressor unit, and the first cooling water circulation flow passage is provided between the first housing and the second housing so as to connect the first housing and the second housing.

5. The gas engine air-conditioning device according to claim 4, wherein the first housing is provided singly, and second housings are arranged in parallel via the first cooling water circulation flow passage.

6. The gas engine air-conditioning device according to claim 4, wherein the first housing is provided singly, second housings are arranged in parallel via the first cooling water circulation flow passage, and each of the second housings is provided with a plurality of indoor units arranged in parallel via a refrigerant circulation passage.

7. The gas engine air-conditioning device according to claim 1, wherein a direct current motor is used as the motor, and a controller is provided to supply appropriate power between the direct current power generator and the motor.

8. The gas engine air-conditioning device according to claim 1, wherein an alternating current motor is used as the motor.

9. A gas engine air-conditioning device comprising an outdoor unit that includes: a gas engine; a first cooling water circulation flow passage and a second cooling water circulation flow passage through which cooling water of the gas engine circulates; a first radiator provided in the first cooling water circulation flow passage; a second radiator provided in the second cooling water circulation flow passage; a water passage switch valve for circulating the cooling water through either the first cooling water circulation flow passage or the second cooling water circulation flow passage; a alternating current power generator driven by the gas engine; a motor operated by the alternating current power generator; a compressor driven by the motor to compress a refrigerant; a condenser for performing heat exchange on the refrigerant; a first fan provided on the first radiator side; and a second fan provided on the second radiator side, the gas engine air-conditioning device configured such that during heating, the cooling water is circulated through the first cooling water circulation flow passage by the water passage switch valve, high-temperature passing air is sent from the first radiator, which reaches a high temperature, to the condenser by the first fan, and the refrigerant compressed by the compressor is circulated to an indoor unit, and during cooling, the cooling water is caused to flow through the second cooling water circulation flow passage by the water passage switch valve, and surplus power generated by the alternating current power generator in accordance with the output of the gas engine is supplied to the outside.

10. The gas engine air-conditioning device according to claim 9, wherein the second fan is capable of changing a direction of passing air sent to the second radiator.

11. The gas engine air-conditioning device according to claim 10, wherein the second fan includes a plurality of blades, each blade has a blade central portion formed in an intermediate location along a rotation direction, the blade central portion having a flat plate shape and inclining along the rotation direction, and blade end portions formed on two rotation direction ends of the blade central portion so as to incline along the rotation direction, and attack angles of the two blade end portions are set to be identical and smaller than an attack angle of the blade central portion.

12. The gas engine air-conditioning device according to claim 2, further comprising an ECU and a TCU, wherein an assembly of the gas engine, the ECU, and the direct current power generator is housed in a first housing as a power unit, an assembly of the motor, the compressor, the condenser, the first radiator, and the first fan is housed in a second housing as a compressor unit, and the first cooling water circulation flow passage is provided between the first housing and the second housing so as to connect the first housing and the second housing.

13. The gas engine air-conditioning device according to claim 2, wherein a direct current motor is used as the motor, and a controller is provided to supply appropriate power between the direct current power generator and the motor.

14. The gas engine air-conditioning device according to claim 2, wherein an alternating current motor is used as the motor.
